(19) United States
(12) Patent Application Publication
(10) Pub. No.: US 2004/0255726 A1
(43) Pub. Date: Dec. 23, 2004

(54) Spring locked wrench

(76) Inventors: Darren J. Kady, Glen Allen, VA (US); David L. Showalter, Barboursville, VA (US); Benny R. Barnes, Madison, VA (US)

Correspondence Address: Parker & DeStefano, P.C., Suite 300, 300 Preston Avenue, Charlottesville, VA, 22902, US

(21) Appl. No.: 10/857,387

(22) Filed: May 29, 2004

Related U.S. Application Data
(60) Provisional application No. 60/474,070, filed on May 29, 2003.

(51) Int. Cl. B25B 13/16

(52) U.S. Cl. 81/165; 81/170

(57) ABSTRACT

The wrench uses a spring driven locking mechanism to lock the movable lower jaw into position. A release bar enables the locking mechanism to be rotated, against the spring tension, to a position that releases the lower jaw for movement. Once released the spring tension returns the locking mechanism to a position that prevents movement of the lower jaw. A spring extending from the top of the stationary jaw into the lower jaw maintains the lower jaw adjacent to the upper jaw. By releasing the locking mechanism, repositioning the wrench without completed removal and then relocking the locking mechanism, the wrench can be used in a ratchet style. The locking mechanism is a multi-toothed semi circle that interacts with the teeth on the lower jaw shaft to engage and disengage the lower jaw.

### CROSS REFERENCE TO PRIOR APPLICATION

This application is a non-provisional conversion of U.S. provisional 60/474,070 filed on May 29, 2003 and incorporates this application as through recited in full.

### BRIEF DESCRIPTION OF THE PRIOR ART

In the most common type of adjustable wrench a worm gear and a journaled jaw member interact to change the relative location of the fixed and movable jaws. A pin rotatably holds the worm gear in a slot that extends through the handle of the wrench. The worm gear contacts a journaled rear portion of the movable jaw. The movable jaw slides in a groove defined by handle to a location controlled by the worm gear. U.S. Pat. No. 2,722,150 shows the general arrangement of this type of wrench. The worm gear arrangement of this typical wrench design always leaves some play between the jaws. This play results in the wrench sometimes slipping under pressure and thus detracting from the reliability of such devices.

Many adjustable wrench designs have been proposed that attempt to improve the adjustability and reliability of such wrenches. Such wrench designs include U.S. Pat. No. 1,397,214 wherein a slot in the handle of wrench retains a grooved wedge that a spring biases toward a slidably mounted movable jaw having complimentary grooves for holding the jaw in position. The movement of the wedge is relatively quick which in turn allows quick adjustment of the wrench.

A number of other quick adjustment wrench designs use a series of wedges or ramps to quickly adjust the position of the movable jaw. Basic wedge designs in adjustable wrenches are well known and depicted in U.S. Pat. Nos. 1,511,526, 1,481,250, 1,004,561, 1,514,017 and 1,427,918. Examples of wedge designs adapted for use in open end adjustable wrenches are shown in U.S. Pat. Nos. 2,948,175 and 1,389,487 wherein a wedge cooperates with an inclined surface to move the wedge forward in compression against an opposing surface of the lower jaw. Pressure exerted by the wedge locks the jaw in place until displacement of the wedge along the surface of the ramp releases the jaw. Another wedge type wrench design is shown in U.S. Pat. No. 4,903,556 where a wedge is contained in an inclined slot that extends through a handle portion of the wrench. The wedge has a flat surface on one side that acts against a surface of the slot and a tapered surface that acts against a tapered surface on the back of a movable jaw.

U.S. Pat. No. 5,231,984 discloses an adjustable wrench design having only two movable elements that uses contact points fixed to a movable jaw to hold the movable jaw in position. The contact points act on a guide member to bind the movable jaw from movement when the wrench is under load. Simple rotation of the movable jaw, once the load is removed, permits ready movement of the jaw to a new position. U.S. Pat. No. 3,817,128 addresses the additional problem of wrenches being bulky and time consuming to close. The '128 patent discloses a wrench with a releasable lock, however the release cannot be easily operated with one hand and requires a sliding motion toward the end of the wrench, making it difficult to use in tight spaces.

None of the foregoing patents, however, resolve the issue of an easy to use wrench that can be opened and closed with one hand. The disclosed wrench overcomes the prior art problems by using a spring loaded rotational locking system operable by rotating a single lever.

### BRIEF DESCRIPTION OF THE DRAWINGS

The advantages of the instant disclosure will become more apparent when read with the specification and the drawings, wherein:

FIG. 1 is a front side view of the disclosed spring locked wrench;

FIG. 2 is a backside view of the disclosed wrench;

FIG. 3 is a cutaway end view of the spring locking system;

FIG. 4 is a cutaway top end view of the spring lock in the locked position;

FIG. 5 is a cutaway top end view of the spring lock in the unlocked position;

FIG. 6 is a side view of the toothed lower jaw showing the spring shaft;

FIG. 7 is a side view of the toothed lower jaw showing the spring shaft with the spring and locking pin inserted;

FIG. 8 is a top view of the multi-toothed locking mechanism;

FIG. 9 is a front side view of the multi-toothed stop interacting with the teeth of the lower jaw;

FIG. 10 is a bottom view of the disclosed wrench;

FIG. 11 is a side view of the coil spring illustrated herein;

FIG. 12 is a top view of the coil spring of FIG. 11;

FIG. 13 is a cutaway to view of the tooth lower jaw with the pin in position;

FIG. 14 is a top view of the spring holding bar;

FIG. 15 is a top view of the wrench;

FIG. 16 is a side view of the bottom pin securing the spring;

FIG. 17 is a front view of the multi-toothed locking mechanism;

FIG. 18 is a top view of the lower jaw;

FIG. 19 is a bottom view of the lower jaw;

FIG. 20 is a side view of an alternate embodiment of the disclosed wrench;

FIG. 21 is a top view of the embodiment of FIG. 20;

FIG. 22 is a cutaway view of the spring retaining pin of FIG. 20;

FIG. 23 is a cutaway perspective of the lower jaw retaining mechanism;

FIG. 24 is a side view of the retaining mechanism of FIG. 23;

FIG. 25 is a side view of an alternate lower retaining mechanism;

FIG. 26 is a side view of the lower jaw of FIG. 25;

FIG. 27 is a side view of an alternate embodiment having an open channel and accessible pin for moving the lower jaw;

FIG. 28 is a cutaway side view of an alternate locking mechanism;

FIG. 29 is a cutaway side view of a cylindrical spring holder;

FIG. 30 is a side view of an alternate embodiment of the disclosed wrench;

FIG. 31 is a side view of another embodiment of the head of the disclosed wrench;

FIG. 32 is a side view of a further embodiment of the jaws of the disclosed wrench;

FIG. 33 is a side view of an alternate embodiment of the shaft teeth of the lower jaw, and

FIG. 34 is a side view of the locking gear mechanism and locking teeth for use with the shaft teeth of FIG. 33, and

FIG. 35 is a top view of the shaft teeth of FIG. 33.

### DETAILED DESCRIPTION OF THE INVENTION

The disclosed wrench enables the user, using one hand, to place the wrench onto the designed object to be moved and then tighten the wrench around the object.

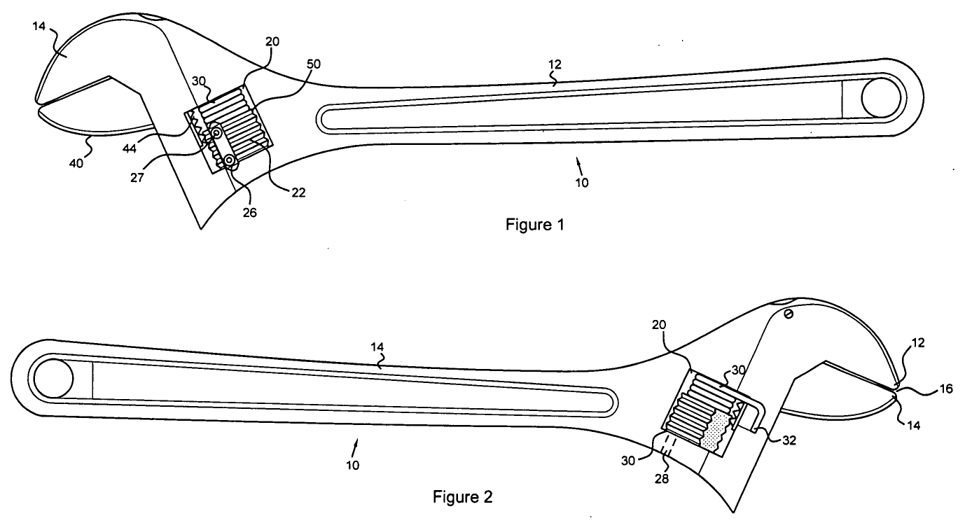

FIGS. 1 and 2 illustrate the wrench 10 in the closed position with FIG. 1 illustrating what will be referred to herein as the front side 12 and FIG. 2 illustrating the backside 14. The locking system 22 illustrated herein is set within the recess 20 that extends through the width of the wrench 10. Alternatively, the locking system can extend partially through or be covered on one or more sides. Further, locking mechanisms other than the cylindrical locking system illustrated herein can be used. For example, the cylinder can be replaced with a flat-sided polygon that slides within the wrench. One side of the polygon would have teeth that interlock, as described hereinafter and the opposing side would have a spring system that biased the polygon toward the open position. This design would permit the option of enclosing one or more sides.

The locking system 22 consists of a multi-toothed locking mechanism 50, a spring 30, or other tension device that creates a similar action, and a release mechanism, or release bar 26. It should be noted that although the locking mechanism illustrated here is a single unit, multiple parts can be used in manufacturing to creating the mechanism. Additionally, the release mechanism can be manufactured integral with the locking mechanism. The locking system 22 is held in place by a lock pin 54, illustrated in FIGS. 4 and 5, which is inserted to, and recessed within, a channel 28. The lock pin 54 can be maintained in the wrench through use of a threaded screw, spot welding, or any other method known in the art. The release bar 26, or other locking mechanism, is used to rotate the multi-toothed locking mechanism 50 from the locked to the unlocked position. The release bar 26 is secured to the multi-toothed locking mechanism 50 through use of one or more screws 27 or other methods known in the art such as welding, pop rivets, keyed fitted, or any other method that would be applicable to the materials of manufacture. The release bar 26 can be any design convenient for manufacturing and can also be placed on the opposite side of the wrench. Alternatively the release bar and the multi-toothed locking mechanism can be molded as a single unit.

As seen in FIG. 4 and 5, the multi-toothed locking mechanism 50 has a semi-circular cross section with a flat side 62. The surface of the locking mechanism 50 contains teeth 58, as illustrated in FIG. 8 and 9, which are separated by grooves 60. In the preferred embodiment, the teeth have flat ends, enabling a tighter to interaction with the toothed locking shaft 42. In the preferred embodiment, the teeth 58 are spaced about 1/16^{th} of an inch from adjacent teeth to provide increased adjustability. Although the spacing can be further apart, the adjustability is lost as the spacing increases.

The teeth 58 and grooves 60 on the multi-toothed locking mechanism 50 are dimensioned to interact with the notches 44 on the locking shaft 42 of the lower jaw 40. As can be seen in the cross-sectional view of FIGS. 4 and 5, the locking shaft 42 is also a flat-sided semi-circle with the notches 44 being placed on the flat side 43. In the preferred embodiment, the notches 44 of the locking shaft 42 are widened along the locking mechanism 50 entry side, or proximal side, narrowing toward the distal side to a flat back. The widening of the proximal side is only at the entrance to the notch 44, with the remaining length of the notch 44 being dimensioned to form a tight interaction with teeth 59 of the locking mechanism 50.

In the embodiment illustrated in FIGS. 17, 18 and 19, the proximal side 90 of the shaft teeth 48 has been shortened as well as the space between the teeth 48 widened. The ensure that the teeth 48 can easily enter at the proximal side 90, the notches 44 at entrance must be deeper in relationship to the un-notched plane 94 than at the distal side 92. By gradually making the shaft notches 44 decrease in depth and width the teeth 60 of the locking mechanism 50 will rest snugly within the notches 44, thereby preventing movement in the locked position. The shortening of the shaft teeth 48 on the proximal side 90 is critical to a smooth entry into the locking shaft 42. The back wall 96 of the shaft notches 44 is preferably flat, matching the flat edges of the teeth 58 of the multi-toothed locking mechanism 50. It is critical, to prevent movement while in the locked position, that the width of the locking teeth 58 of the multi-toothed locking mechanism 50 be only slightly less than the width of the shaft notches 44, thereby enabling the locking teeth 58 to be locked tightly within the shaft notches 44. Additionally, the length of the locking teeth 58 must be such that the teeth 58 can extend into the back wall 96 of the shaft notches 44, thereby further reducing any movement. In some designs, it can be beneficial to deepen the notch 44 to enable more interaction between the notch and the teeth.

In embodiments where the front of the notches are not tapered as described heretofore, the teeth of the locking mechanism can potentially not interlock as tightly, thereby allowing some minor slippage when in the locked position.

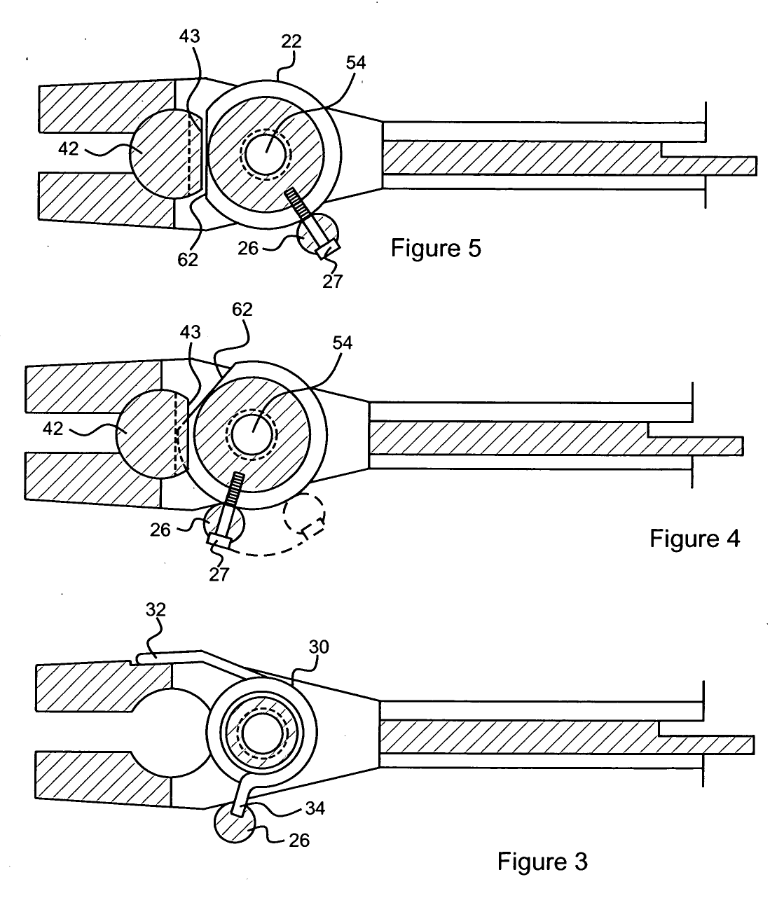

To provide the automatic return of the locking mechanism 50 a spring 30 is used in combination with a release bar 26 to enable easy movement of the spring 30. The spring 30 is secured to the locking mechanism 50 through any means known in the art, with the criticality being that the locking mechanism 50 must move with the spring 30. The spring 30 is secured to the release bar 26, as seen in FIG. 3, through use of the entry arm 34. By securing the spring 30 to the release bar 26, both the spring 30 and the locking mechanism 50 are moved during movement of the release bar 26. The spring 30 is positioned so as to bias the multi-toothed locking mechanism 50 in the locked position through the positioning of the support end 32 of the spring 30 on the wrench back 14. The spring and release bar can be a separate, or integral, units and the design will depend upon manufacturing costs. Additionally, although a coil spring is illustrated herein, it should be noted that any type of spring could be used that will provide the results described herein.

Alternatively, a multi-toothed locking mechanism can be used that contains sufficient space to enable a spring mechanism to interact with the lock pin and the locking mechanism. In this embodiment, illustrated in FIG. 28, a spring 102 is placed within the multi-tooth cylinder 110 (teeth not shown) with a locking prong 108 extending from the spring 102 into the cylinder 110. A second locking prong 106 protrudes into the lock pin 104, thereby maintaining the cylinder 110 in a specific at rest position in relationship to the lock pin 104. This embodiment would then function as described heretofore. This embodiment enables additional teeth to be added to the locking mechanism allowing for better gripping.

In FIG. 4 the locking system 22 is in the locked position with the release bar 26 toward the forward jaw of the wrench 10. As can be seen, the locking teeth 58 are recessed into the shaft notches 44 thereby prevent movement of the lower jaw 40. In FIG. 5, the release bar 26 has been moved to the of the unlock position, moving the flat side 62 of the locking mechanism 50 into alignment with the flat side 43 of the locking shaft 42. This enables the locking shaft 42 to move in relation to the upper jaw 14. Once the release bar 26 is released, it is forced to the rest, or locked, position by the spring 30, thereby rotating the locking teeth 58 back to a position to interact with the shaft notches 44.

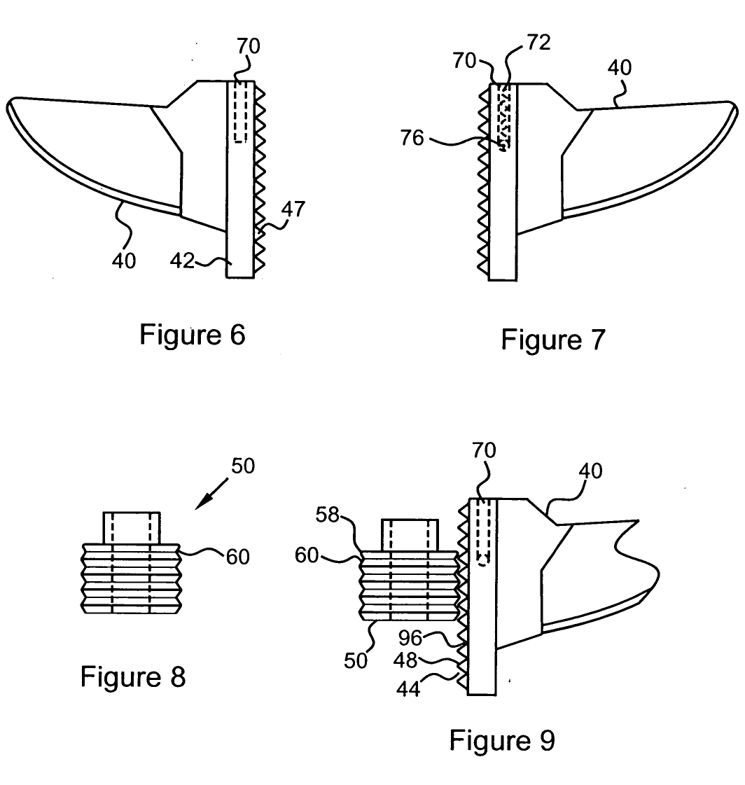

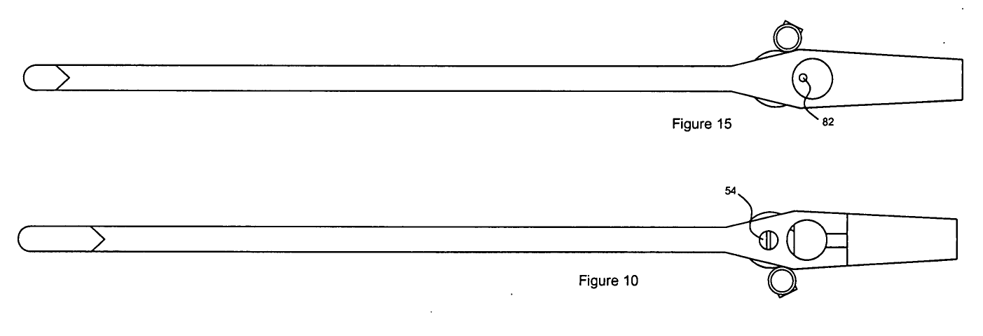

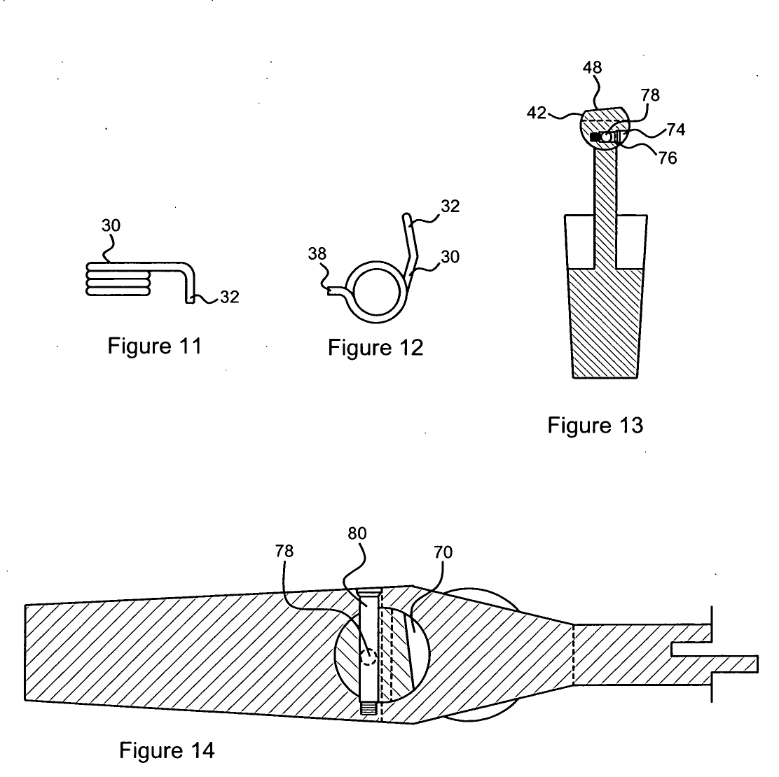

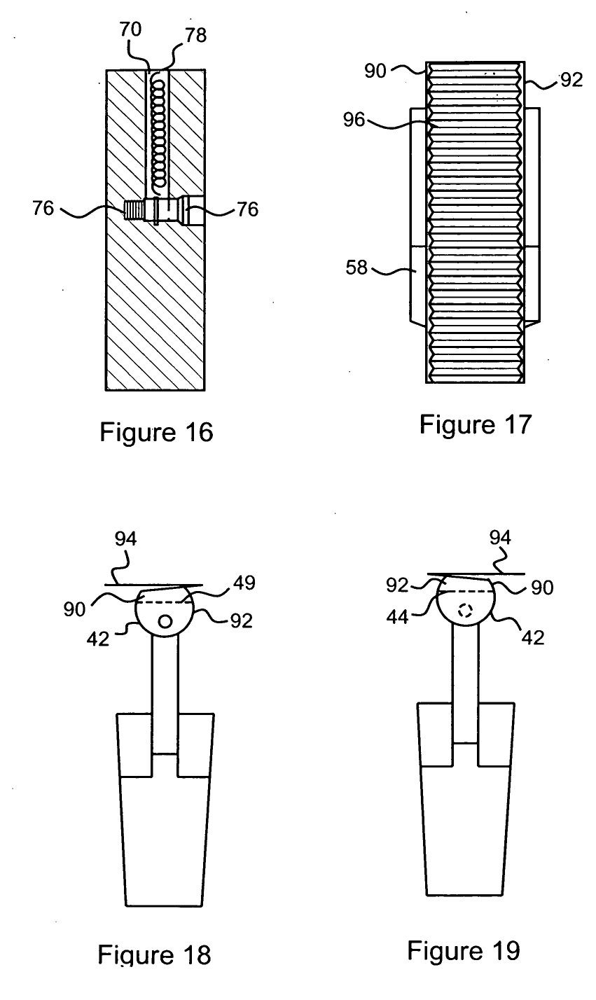

In order the return the lower jaw 40 to the closed position upon release of the locking system 20, a spring 72 is used to pull the lower jaw 40 back to the closed, or at rest, position. In the preferred embodiment a spring channel 70 is drilled, or molded, into the locking shaft 42, as seen in FIGS. 6, 7, 13, 14 and 16. A perpendicular counter channel 74 is drilled to intersect the bottom, or closed end, of the spring channel 70. A spring 72, having a looped bottom end, is placed into the chamber 70 and the bottom end secured by placing a locking pin 76 through the looped end. The locking pin 76 is then secured, either to the opposing wall or within the entry wall. The method of securing the locking pin will be dependent upon the design of the pin or screw and will be evident to those skilled in the art. Alternatively, the locking pin could have a spring receiving hole through which the spring is placed. Although not mandatory, the locking pin can also have a notch to receive the spring. The locking pin can be a screw that is threaded into the opposing wall and can be either permanently secured or removable. When a screw is used, it is preferred that it is countersunk and that the end is tapered, in order to lock the screw tightly into the locking shaft 42. Other ways to secure the spring could be a regular metal screw, pin, rivet, molded hook on the inside of the chamber, or other methods known in the art.

The use of the spring 72 to maintain the lower jaw 40 in a closed position when at rest enables the wrench 10 to release it's grip on a nut and then reapplied without resetting or otherwise adjusting the wrench 10. By disengaging the lock teeth 50 from the shaft teeth 48, the lower jaw 40 is free to move, however it cannot fall due to the spring 72. This enables the wrench 10 to be removed from the nut and then reapplied and relocked by releasing the release bar 26, to again securely grip the nut. This provides a similar action to that of a ratchet wrench with the versatility of an adjustable wrench

Alternatively, the spring channel can be drilled completely through the length of the locking shaft. The spring would then be secured at the open top and open bottom by a number of methods such as screws, pins, rivets, etc.

The other end of the spring 72 is secured to a support bar 80, as shown in FIG. 14, that is recessed into the top of the wrench 10 and then capped, as shown in FIG. 15, with a plastic, or other material, cap 82 to prevent dirt from entering the channel 70. The support bar 80 can be secured in any of the ways discussed herein, including a screw, pin, rivet, etc.

Alternatively, as seen in FIG. 29, the channel can be threaded and a threaded cylinder 150, containing a spring 152 that is secured to the top of the open ended cylinder 150. The cap 156 of the cylinder 150 is secured to the wrench body, thereby remaining stationary to provide the resistance required to return the bottom jaw to the closed position once the locking mechanism is released. In the illustration of FIG. 29, the spring 152 is hooked to the bottom loop 158 located on the lower jaw shaft at one end and the cap loop 154 at the other, although other methods of securing the spring can be used. The top 156, which screws into the wrench, is removable, thereby enabling the spring 152 to be replaced.

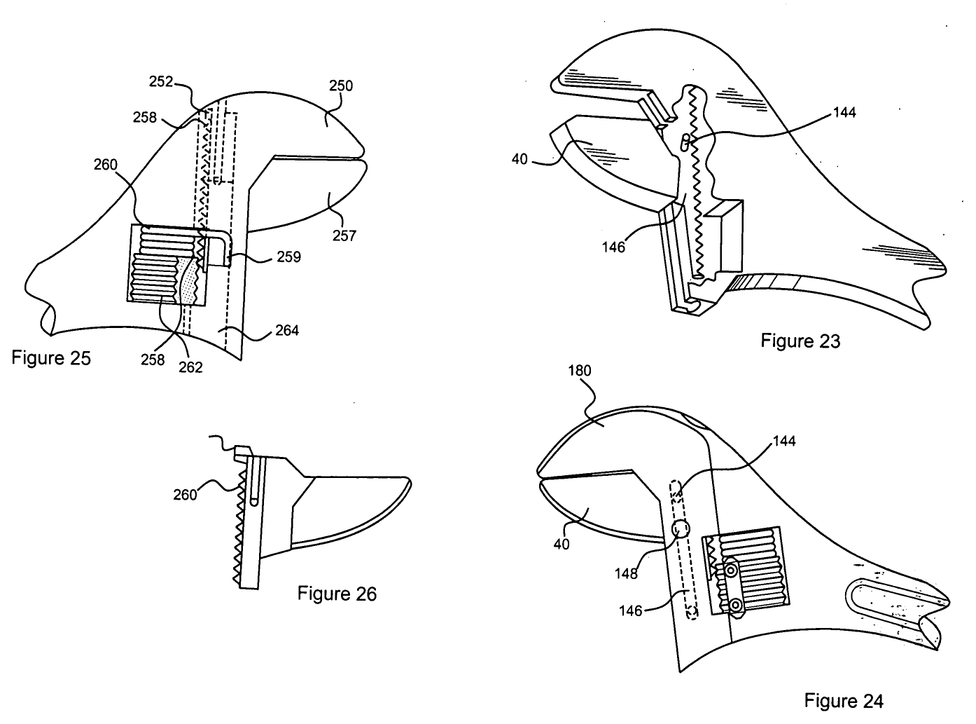

In order to enable the lower jaw 40 to move, a channel 146 is molded on the inside of the wrench body 180. An access port 148 is drilled through the body 180 into the channel 146. A threaded hole is drilled into the body of the lower jaw 40 at a location that will align the threaded hole with the channel 146. The threaded hole is aligned with the access port 148 and a pin 144, either partially or fully threaded, is placed into the threaded hole. The pin 144 must be dimensioned to permit the lower jaw 40 to move freely within the wrench body 180 along the channel 146. A removable plug (not shown) is placed over or into the access port 148 to prevent dirt and other debris from entering. Although any method can be used to cover the access port 148, a removable plug provides advantage that the threaded pin 144 can be removed and the wrench rebuilt. Although the access port 148 and channel 146 are shown on the front side of the wrench in FIGS. 23 and 24, it should be noted that the channel and access port could be placed on either the front or the back. This is especially applicable in heavier wrenches, where it could be advantageous to have duel interior channels and the pin extending through the lower jaw to ride in both channels. The plug can also have a drain hole to permit liquid that has entered the wrench through the cutout to escape.

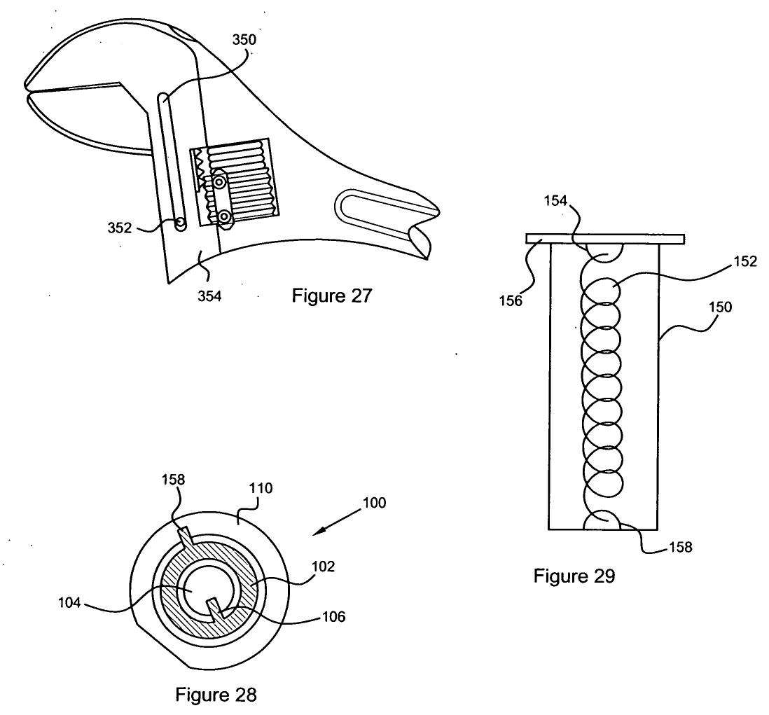

Alternatively, as illustrated in FIG. 27, a channel can be cut completely through the wrench 354, creating an open channel 350. The pin 352 would then protrude through the front of the wrench 354, allow for a manual sliding of the lower jaw.

The ends 12 and 14 of the wrench 10 are curved or V-shaped to form an entry port 16 that enables an object, such as a nut, bolt, pipe, etc., to be inserted merely by releasing the release bar 26 and forcing the wrench 10 forward. Alternatively, a set of rollers can be attached to the tip of the wrench. Once the release bar 26 is released, the lower jaw 40 of the wrench 10 is free to move. However, the spring 72 prevents the lower jaw 40 from merely dropping to the most extended position. Thus, the tension of the spring 72 permits the lower jaw 40 only to separate a sufficient distance to enable the object to be placed between the jaws. If the jaw is over extended when pressed onto an object, the lower jaw 40 will tighten against the object instantly while the release bar 26 is in the release position. Once the moving jaw 40 is against the nut or item, release of the release bar 26 will secure the object and the wrench 10 will be ready to operate.

In all embodiments, the lower jaw can be opened manually by placing the locking mechanism in the unlocked position, moving the jaw to the desired position, and releasing the locking mechanism. The wrench is then placed over the object and the locking mechanism again placed in the unlocked position. This permits the spring to pull the lower jaw tight against the object. The release of the locking mechanism locks the lower jaw in the usable position.

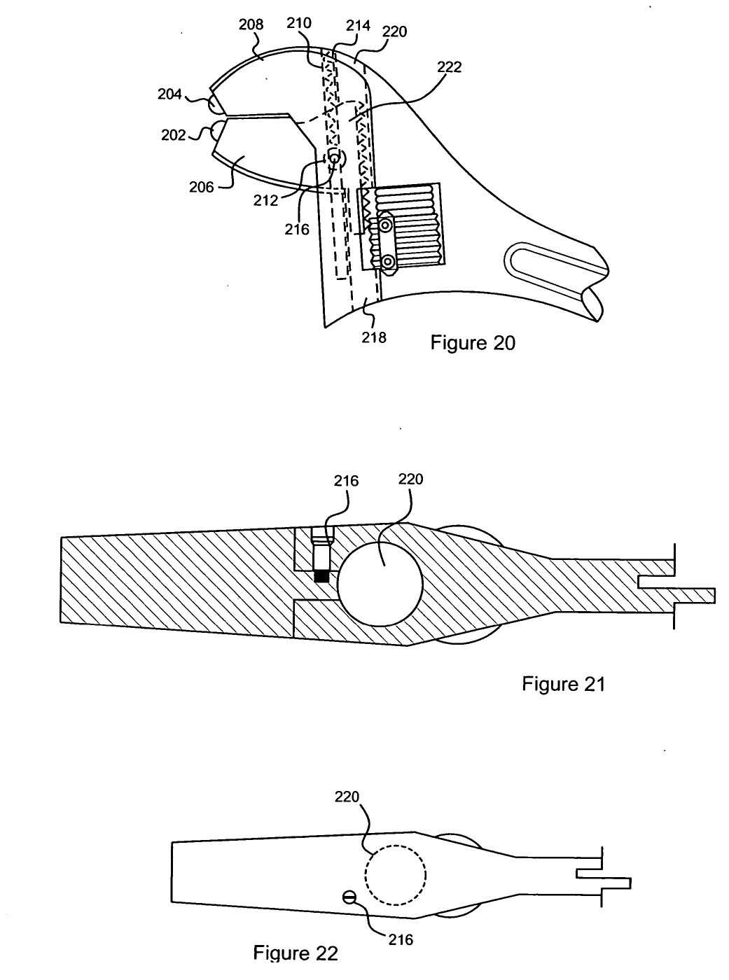

In an alternate embodiment, as illustrated in FIG. 20, rollers 202 and 204 are put on the end of the upper jaw 208 and lower jaw 206. The rollers 202 and 204 facilitate the placement of the jaws 206 and 208 onto an object by simply pressing forward. FIG. 20, 21 and 22 illustrate another embodiment incorporating an alternative method of attaching the lower jaw spring to enable the lower jaw to return to the closed position upon releasing the locking mechanism. A channel 210 is drilled on one side of the stationary upper jaw 208. An access port 2!2 is drilled though the exterior of the body 218 into the channel 210. A spring 214, having a looped end, is placed into the channel 210 and a pin or screw 216, placed through the looped end of the spring 214 and secured to the opposing side by means noted heretofore. The screw 216 must be sufficiently recessed to enable the lower jaw 40 to slide freely. In this embodiment, there is some loss of integrity as the wrench head is weakened. To compensate for the loss of strength through removal of material for the channel 210, the wrench is reinforced. The lower jaw 206 moves through an open area 220 within the wrench sides. Much of this area is unused and left empty for weight issues. In the disclosed wrench, the wrench shaft 222 is shortened by about 13 mm, which does not affect the functioning of the wrench. This enables about 3 mm of steel to be placed in the bottom and about 6mm in the top of the open area channel within which the wrench shaft 222 runs. In this embodiment, a small drain should be placed in the bottom filler to prevent liquids from accumulating. Although other methods of attaching a spring can provide the same affect as disclosed heretofore, care must be taken not to compromise the integrity of the wrench.

In FIGS. 25 and 26, an alternate embodiment is disclosed wherein the bottom jaw 250 is prevented from being completely removed from the wrench 248. The bottom jaw 250 is manufactured with a stop flange 252 that extends beyond the teeth 258 at the top of the jaw 250. The stop flange 252 must have sufficient length to catch on the locking mechanism 262 as the lower jaw 251 drops. In the embodiment illustrated in FIG. 25, the spring 260 has been reduced in diameter to provide a ledge 259 to catch the stop flange 252. Alternatively, the spring 260 can have the same diameter as the locking mechanism 262 with the stop flange 252 being stopped by the spring 260. As another embodiment, a mating flange, screw, pin, stop or shelf, can be manufactured or inserted within the travel channel 264 to create a stop for the lower jaw.

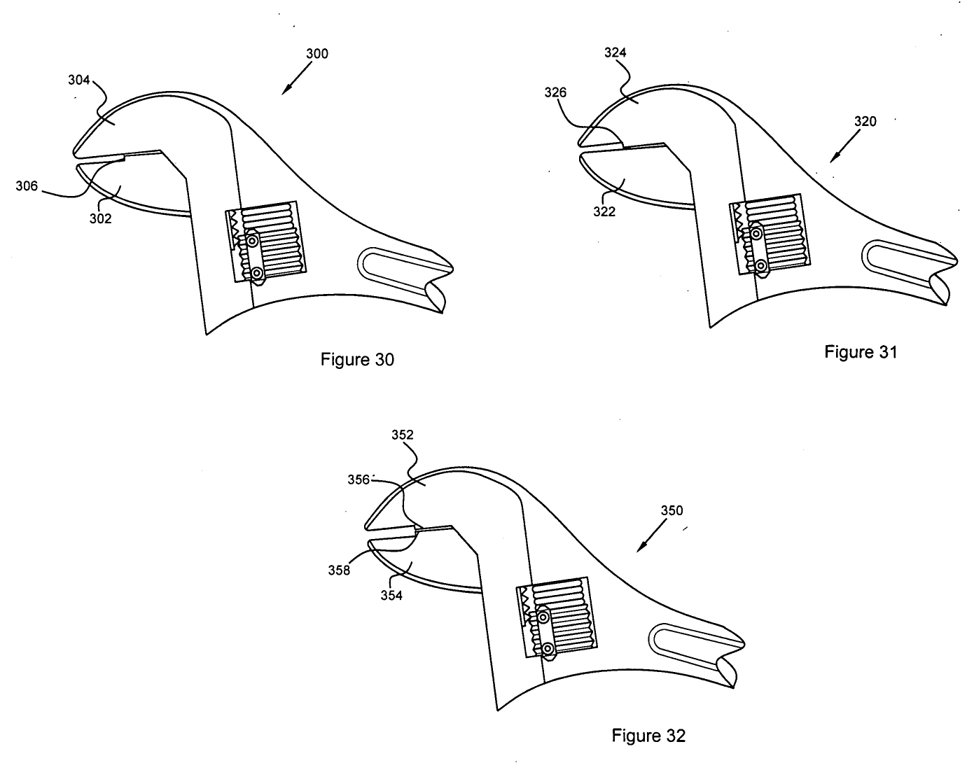

In the embodiment illustrated in FIG. 30, the length of the lower jaw 302 and upper jaw 304 wrench 300 have been extended to provide additional space within the “mouth∞ of the wrench 300. To easily accommodate for both metric and standard sizing, the lower jaw 302 is manufactured with a step 306 that reduces the distance between the lower jaw 302 and the upper jaw 304. The step must be within the range to accommodate the metric/standard differential. The incorporation of the step 306 enables the wrench 300 to be used for both the metric and standard sizing by providing two differently sized locations within the wrench 300 mouth. In FIG. 31 the wrench 320 has the step 326 on the stationary, upper jaw 324 rather than the bottom jaw 322. The operation of this embodiment is the same as the embodiment of FIG. 30 with only the placement of the step differing.

In FIG. 32, the wrench 350 has an upper jaw step 356 in the upper jaw 352 and a lower jaw step 358 in the lower jaw 354. It should be noted that when the dual steps are used, the height of the step needs to be divided so that both sizes total the difference needed accommodate the metric/standard differential.

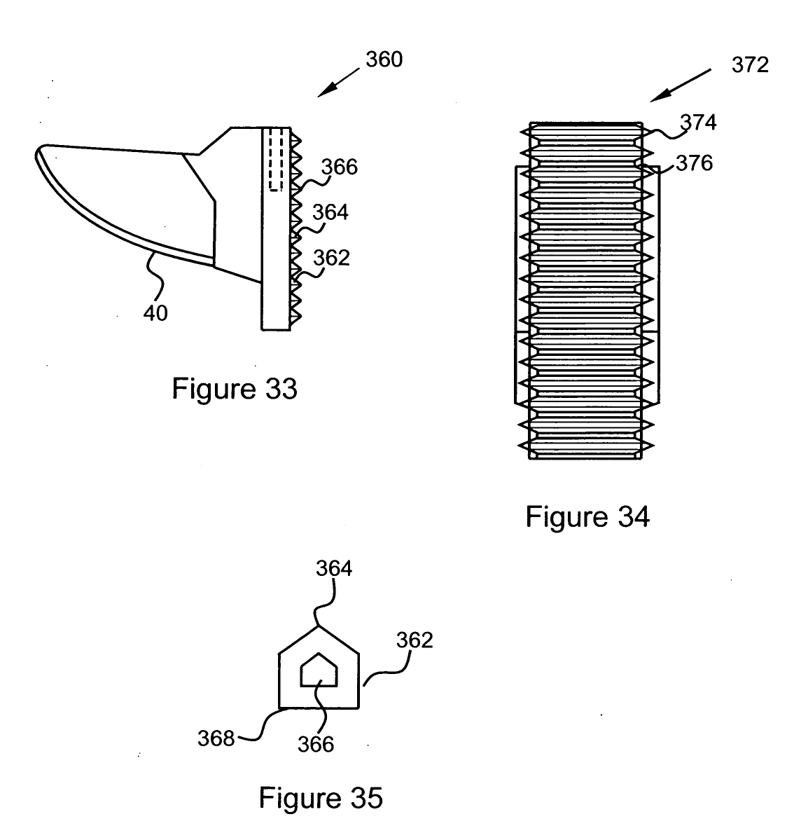

Another method of accommodating the metric/standard differential is illustrated in FIGS. 33 and 34. In FIGS. 33 and 35, the locking shaft teeth have been manufactured with a pointed entry side 364 and an opposing flat side 368. The top 366 of the teeth 362 in this illustration is pointed, however the top can remain flat as in previous embodiments.

The locking mechanism 372 of FIG. 34 is manufactured with pointed locking teeth 374 rather than the flat-topped teeth of prior embodiments. The notches 376 can remain configured as described heretofore with the flat receiving back wall or also manufactured in a V shape. However, in all configurations, for optimum performance, the notches 376 are deeper than prior embodiments.

The shaft teeth 362 are manufactured so that the pointed entry side 364 is the entry side for the locking teeth 374. This design enables the two pointed surfaces to easily mate and for the locking teeth 374 to slide as deeply into the shaft notches 376 as required to close on the object being gripped. In order for this embodiment to function optimally, the play between the locking mechanism 372 and the shaft 360 must be minimal.

In the above embodiment, the pointed locking teeth 374 enter into the shaft notches 376 one depth for standard and another depth for metric. The bearing points will be on the side of the wall of the notches 376 that is making the contact with the locking teeth 374, with the location of the bearing points being dependent upon the size of the nut between the jaws.

The jaw grip disclosed in full in U.S. Provisional 60/402,146 filed Aug. 9, 2002, which is incorporated herein as though recited in full, can be used as well as any other ratchetable mechanism.

What is claimed is:

1. An adjustable wrench having a body, a stationary upper jaw integral with said body, a tip and a gripping surface and a moveable lower jaw having a tip, a gripping surface and a shaft, the improvements comprising:
A locking mechanism, said locking mechanism being rotatably secured within said body proximate said shaft, a first portion of said locking mechanism having multiple locking teeth with locking notches there between and a second portion of said locking mechanism having no locking teeth,
Multiple shaft teeth with shaft notches there between on said shaft, said shaft teeth being dimensioned and positioned on said shaft to engage with said locking teeth to prevent movement of said shaft,
Locking spring, said locking spring interacting with said locking mechanism to maintain said locking teeth in engagement with said shaft teeth when at rest,
A release mechanism, said release mechanism to rotate said locking mechanism against said spring to place said portion of said locking mechanism having no teeth adjacent to said shaft teeth to release said shaft.

2. The wrench of claim 1 wherein said locking mechanism has a curved side with said multiple locking teeth to engage said multiple shaft teeth and a flat side having no teeth to permit movement of said shaft.

3. The wrench of claim 2 wherein said multiple locking teeth have a leading edge for first rotational engagement with said shaft teeth, said multiple locking teeth at said leading edge having a length less than said multiple locking teeth in engagement with said shaft teeth when at rest.

4. The wrench of claim 2 wherein said multiple locking teeth have a leading edge for first rotational engagement with said shaft teeth, said multiple locking teeth at said leading edge having a distance between said multiple locking teeth greater than said multiple locking teeth in engagement with said shaft teeth when at rest to create wider notches at said leading edge.

5. The wrench of claim 2 wherein said multiple locking teeth are pointed.

6. The wrench of claim 2 wherein said shaft teeth have a leading edge for first rotational engagement with said multiple locking teeth, said shaft teeth at said leading edge being pointed.

7. The wrench of claim 2 wherein said shaft teeth have a leading edge for first rotational engagement with said multiple locking teeth, said shaft teeth at said leading edge being flat.

8. The wrench of claim 1 further comprising a lower jaw spring assembly, said spring assembly having a jaw spring within a spring receiving channel that extends through said body into said shaft, said spring being secured at each end within said spring receiving channel to maintain said lower jaw adjacent said upper jaw when at rest.

9. The wrench of claim 8 wherein said spring receiving channel extends through said shaft to be secured on the exterior end of said shaft.

10. The wrench of claim 8 wherein said lower jaw spring assembly maintains said lower jaw adjacent an object upon release of said locking mechanism to enable repositioning and relocking of said locking mechanism for continued use.

11. The wrench of claim 1 wherein said locking teeth are spaced about 1/16^{th} of an inch from an adjacent tooth.

12. The wrench of claim 1 wherein said locking spring is integral with said locking mechanism.

13. The wrench of claim 1 wherein said upper jaw and said lower jaw have tapered tips.

14. The wrench of claim 1 further comprising at least one step within a portion of at least one of said lower jaw gripping surface and said upper jaw gripping surface, each of said at least one step narrowing the distance between said lower jaw gripping surface and said upper jaw gripping surface.

15. The wrench of claim 1 wherein at least one of said tip of said upper jaw and said tip of said lower jaw have rollers.

16. The wrench of claim 1 further comprising a lower jaw retaining member, said lower jaw retaining member to prevent removal of said lower jaw from said wrench.

17. The wrench of claim 16 wherein said lower jaw retaining member is a flange positioned on said shaft to prevent movement of said flange past said locking mechanism spring.

18. The wrench of claim 16 wherein said lower jaw retaining member is at least one channel within said body parallel to said shaft with at least one locking pin extending from said shaft into said at least one channel to limit lower jaw movement to said locking pin movement within said channel.

19. The wrench of claim 1 wherein said locking teeth have a flat top.

20. The wrench of claim 19 wherein said shaft notches have a flat back to interlock with said locking teeth.

21. The wrench of claim 1 wherein said locking teeth are spaced about 1 mm from an adjacent tooth.

22. The wrench of claim 1 wherein said first portion and said second portion are integral.

23. The wrench of claim 1 wherein said first portion and said second portion are at least two parts.

24. An adjustable wrench having a body, a stationary upper jaw integral with said body, a tip and a gripping surface and a moveable lower jaw having a tip, a gripping surface and a shaft, the improvements comprising:
A locking mechanism, said locking mechanism being rotatably secured within said body, said locking mechanism having a curved side with multiple locking teeth and a flat side, having no teeth, said locking mechanism being positioned within said body to enable said multiple locking teeth to have contact with said shaft and said flat side to have no contact with said shaft,
Multiple shaft teeth on said shaft, said shaft teeth being dimensioned and positioned on said shaft to engage with said locking teeth to prevent movement of said shaft,
Locking spring, said locking spring interacting with said locking mechanism to maintain said locking mechanism in engagement with said shaft teeth when at rest,
A release mechanism, said release mechanism rotating said locking mechanism against said spring to place said flat side adjacent to said shaft teeth to release said shaft,
a lower jaw spring assembly, said spring assembly having a jaw spring within a spring receiving channel that extends through said body into said shaft, said spring being secured at each end within said spring receiving channel to maintain said lower jaw adjacent said upper jaw when at rest,
a lower jaw retaining member, said lower jaw retaining member to prevent removal of said lower jaw from said wrench.

25. The wrench of claim 24 wherein said multiple locking teeth have a leading edge for first rotational engagement with said shaft teeth, said multiple locking teeth at said leading edge having a length less than said multiple locking teeth in engagement with said shaft teeth when at rest.

26. The method of gripping and releasing an object using a wrench having a body, a stationary upper jaw and a movable lower jaw, comprising the steps:
a. Rotating a release mechanism to rotate a spring loaded locking mechanism within said body to a disengaged position relative to said lower jaw shaft;
b. Sliding said object between said stationary upper jaw and said movable lower jaw;
c. Releasing said release mechanism to return said spring loaded locking mechanism to an engaged position between said body and said movable lower jaw.
